(19) United States
(12) Patent Application Publication
(10) Pub. No.: US 2023/0301475 A1
(43) Pub. Date: Sep. 28, 2023

(54) VACUUM CLEANER FOR INTERIOR OF VEHICLE

(71) Applicant: Volvo Truck Corporation, Göteborg (SE)

(72) Inventors: Imthias Basheer, Kallakuruchi (IN); Zenitha Chronéer, Torslanda (SE); Manjunath Beerannavar, Bangalore (IN); Lokesh Velayutham, Bangalore (IN)

(21) Appl. No.: 18/122,479

(22) Filed: Mar. 16, 2023

(30) Foreign Application Priority Data
Mar. 25, 2022 (EP) 22164558.3

(51) Int. Cl. A47L 7/00; A47L 9/24; A47L 9/14; A47L 5/36; B60S 3/00; B60H 3/06

(52) U.S. Cl. CPC A47L 7/0076; A47L 9/248; A47L 9/242; A47L 9/1409; A47L 9/149; A47L 5/36; B60S 3/008; B60H 3/06

(57) ABSTRACT

A vacuum cleaner comprising a connecting device to a thermal control system of a vehicle, a flexible hose with a connection end on the connecting device for creating suction into the flexible hose, and a dust collecting box mounted onto the flexible hose.

### RELATED APPLICATIONS

The present application claims priority to European Patent Application No. 22164558.3, filed on Mar. 25, 2022, and entitled “VACUUM CLEANER FOR INTERIOR OF VEHICLE,” which is incorporated herein by reference in its entirety.

### TECHNICAL FIELD

The invention relates to a portable vacuum cleaner for interior of vehicle and truck equipped with a portable vacuum cleaner according to the invention.

The invention can be applied in heavy-duty vehicles, such as trucks, buses and construction equipment. Although the invention will be described with respect to a truck, the invention is not restricted to this particular vehicle and also may be used in car.

### BACKGROUND

When driving a truck over long distances, the driver may have to sleep, eat or rest in the truck cab. In order to maintain a satisfactory driving and living environment in the cab, regular cleaning of the canine is desirable. The current solutions for this cleaning consist either in going to cleaning stations equipped with hoovers, or possibly in using a portable hoover powered via the cab's electrical circuit. These solutions are not entirely satisfactory. Indeed, access to cleaning stations is not always possible for trucks. The cost of a portable hoover is significant. In addition, the performance of portable hoovers compatible with operation on the electrical circuit of the truck cab is poor.

### SUMMARY

An object of the invention is to provide a high performance, low cost, portable hoover that is easy to use in the cab or interior of a vehicle.

The object is achieved by a vacuum cleaner comprising connecting device to a thermal control system of a vehicle, flexible hose with a connection end to connecting device for creating suction into flexible hose dust collecting box mounted onto flexible hose.

Simple structure of vacuum cleaner according to the invention reduces its cost. In addition, vacuum is created by the air conditioning system of the vehicle. Then, there is no additional energy consummation.

According to one embodiment, dust collecting box comprises a removable filter for cleaning or maintenance.

According to one embodiment, dust collecting box is removable for cleaning or maintenance.

According to one embodiment, connection device comprises attachment element to an inlet blower of thermal control system of a vehicle.

According to one embodiment, attachment element comprises sealing element to ensure airtight between connection device and thermal control system of a vehicle.

According to one embodiment, flexible hose comprises a vacuum head.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic view of a thermal unit of a vehicle that could be use with vacuum cleaner of the invention, and

FIG. 2 is a schematic view of a vacuum cleaner according to the invention.

### DETAILED DESCRIPTION

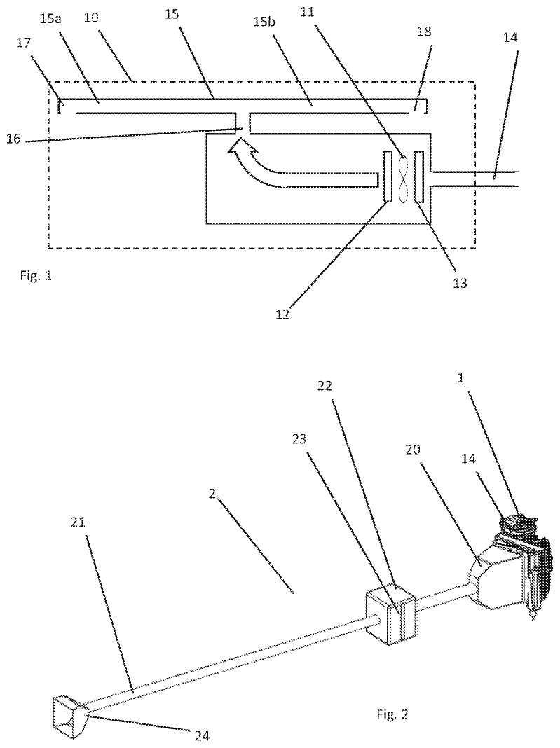

In reference to FIG. 1, a thermal unit 10 of vehicle can typically include a fan 11, a heater 12 and a cooler 13. By means of the fan 11, outside air can be sucked in a channel 14, can enter the thermal unit 10 and pass through the heater 12 and the cooler 13. Therefore, the thermal unit 10 can provide a heated or cooled air flow F which will be directed towards the user compartment of the vehicle. In practice, the heater 12 can be a radiator, and the cooler 13 can be an evaporator forming part of a refrigerant circuit of an air conditioning system. Such a refrigerant circuit typically carries a refrigerant in a loop through a compressor, a condenser, an expander and an evaporator capable of cooling an air flow directed towards the user compartment.

The thermal control system 10 also comprises air circuits connected to the thermal unit 10 and designed to carry some of the air flow towards various locations in the cabin and to blow it inside the user compartment.

FIG. 1 shows one air circuit 15 which has an inlet 16 connected to the thermal unit 10 and two outlets 17, 18 through which an air sub flow is blown towards the user compartment. The outlets may be located near each one of the cabin side walls. More specifically, the air circuit 15 can include:
a first duct 15a having a first outlet 17 which opens towards driver seat, for blowing air towards the driver's torso;
and a second duct 15b having a second outlet 18 which opens towards the passenger seat, for blowing air towards the passenger's torso;

the first and second ducts 15a, 15b being connected to the same inlet 16.

Part of the air blown through outlets 17, 18 could also be directed towards the corresponding adjacent side wall. Although this is not illustrated, the air circuit 15 could be provided with more ducts and/or more outlets.

In FIG. 2, The thermal control system 1 may comprise other air circuits (not shown), such as: an air conduit for blowing air towards the windscreen and/or the head of the cabin occupant(s); an air conduit for blowing air towards the feet of the cabin occupant(s) and/or the area located along the lower part of the side walls.

With reference to FIG. 2, portable vacuum cleaner 2 according to the invention comprises a connecting device 20 to the external air duct 14 of the vehicle thermal control system 1. The portable vacuum cleaner 2 also comprises a flexible hose 21 connected to the connection device and the other end of which is equipped with a suction head 24.

The portable vacuum cleaner 2 according to the invention also comprises a dust collection tray 22 mounted on the flexible hose 21. The dust collection tray 22 may comprise a dust filter 23. The dust filter 23 is, for example, removably mounted in dust tray 22 The dust tray 22 is, for example, removably mounted on the flexible hose 21. For this purpose, the hose 21 and the dust container comprise connecting elements for maintaining an airtight seal between the hose 21 and the dust container 22. For example, the connecting elements comprise a sleeve mounted on the hose 21 and a hole in the dust container 22. The sleeve is then pressed into the dust container opening 22. A seal may be present in the dust container opening 22 to ensure a seal between the hose sleeve 21 and the dust container 22.

The connection device 20 of portable vacuum cleaner 2 according to the invention may comprise locking elements for holding on portable vacuum cleaner 2 upstream of the fan 11 of the thermal control device 1. The locking elements also allow the Vacuum cleaner 2 to be disengaged from the thermal control device 1 when vacuum cleaner 2 is no longer in use.

It is to be understood that the present invention is not limited to the embodiments described above and illustrated in the drawings; rather, the skilled person will recognize that many changes and modifications may be made within the scope of the appended claims.

1. A vacuum cleaner comprising:
a connecting device for a thermal control system of a vehicle,
a flexible hose with a connection end on the connecting device for creating suction into a flexible hose, and
a dust collecting box mounted onto the flexible hose.

2. The vacuum cleaner of claim 1, wherein the dust collecting box comprises a removable filter for cleaning or maintenance.

3. The vacuum cleaner of claim 1, wherein the dust collecting box is removable for cleaning or maintenance.

4. The vacuum cleaner of claim 1, wherein the connection device comprises an attachment element to an inlet blower of the thermal control system of the vehicle.

5. The vacuum cleaner of claim 4, wherein the attachment element comprises a sealing element to ensure an airtight connection between the connection device and the thermal control system of the vehicle.

6. The vacuum cleaner of claim 1, wherein the flexible hose comprises a vacuum head.
